(19) United States
(12) Patent Application Publication
(10) Pub. No.: US 2016/0145442 A1
(43) Pub. Date: May 26, 2016

(54) METHODS OF PRE-TREATING EQUIPMENT USED IN WATER SYSTEMS

(71) Applicant: ChemTreat, Inc., Glen Allen, VA (US)

(72) Inventors: Rajendra Prasad KALAKODIMI, Richmond, VA (US); John RICHARDSON, Richmond, VA (US); Kevin EMERY, Richmond, VA (US)

(21) Appl. No.: 14/549,241

(22) Filed: Nov. 20, 2014

(51) Int. Cl. C09D 5/08; B05D 3/00

(52) U.S. Cl. CPC C09D 5/08; B05D 3/002

(57) ABSTRACT

Methods for preventing corrosion of equipment having a corrodible metal surface that contacts water in a water system, the method comprising pre-treating the corrodible metal surface before the equipment is brought into service in the water system, the pre-treating including contacting a stannous corrosion inhibitor with the corrodible metal surface, wherein the stannous corrosion inhibitor is provided in sufficient amount and for sufficient time to form a protective film on at least a portion of the corrodible metal surface.

### TECHNICAL FIELD

This application is directed to methods for pre-treating equipment used in water systems, such as heat exchangers, pipes, boiler equipment, storage tanks and the like. More specifically, this application is directed to pre-treating such equipment before it is brought into service in the water system new or after a shutdown. For purposes of this application, equipment that has not been used in a water system and in contact with the water or has been used for less than 100 hours in contact with the water should be considered as being not in service and thus available for the pre-treatment methods described herein.

### BACKGROUND

Corrosion of corrodible metallic surfaces used in equipment in industrial water systems is a significant problem. Passivation of corrodible metallic surfaces in water systems protects against flash corrosion. The importance of initial passivation of equipment that comes in contact with water systems has been recognized for more than 50 years. In the absence of proper passivation prior to being placed into service, rapid initial corrosion of infrastructure like heat exchangers and piping is likely to occur. This initial corrosion is difficult to overcome after the system has been placed into normal operation and thus can be resource and cost intensive.

The passivation process not only extends the life of the equipment, but also reduces the scaling or fouling tendency of the infrastructure, leading to improved energy efficiency. Passivation renders the surface less reactive chemically, making it less susceptible to corrosion, scaling, and microbiological fouling.

Historically, chromate-based treatments were used for pre-passivating equipment by virtue of their ability to form a durable passive film. However, in many cases, chromate-based treatments were prohibited or severely restricted due to environmental health and safety concerns. More recently, orthophosphate, polyphosphate, molybdate, nitrite and zinc-based treatments have been used for pre-passivation. These programs, when used in very high concentrations, such as >500 ppm phosphates and >50 ppm zinc, and >50 ppm molybdate, and >1,000 ppm nitrites, are known to produce a protective film on steel surfaces. Azoles are used for pre-passivating copper metallurgy.

There are multiple issues associated with using these compositions as pre-passivating treatments. For example, they frequently do not form effective films. Minor changes in environment, such as pH depression, can destroy the film, and corrosion products can accumulate before the film is reestablished through normal treatment. Also, due to the tendency for zinc and phosphate to precipitate on heat transfer surfaces when applied at high levels, which are required to form a robust passive film. Additionally, discharge of chemicals such as phosphates and zinc is often limited by environmental regulations, and industries face significant regulatory barriers in discharging the passivation solution containing high levels of these chemicals. Further, due to these environmental regulations and the excessive cost of applying effective high treatment levels to an entire water system, the pre-passivation procedure is often practically limited to isolating and passivating individual critical components as opposed to passivating the entire water system including piping. In some cases, the system design must be altered to include provisions for isolating individual heat exchangers and critical equipment.

### SUMMARY

These and other issues are addressed by the present disclosure. It is an object of this disclosure to provide a non-phosphorus and non-zinc, non-molybdate, non-nitrite-based environmentally friendly, pre-passivation program that can be cost-effectively applied to the infrastructure of industrial water systems, including individual components, through the application of stannous-based corrosion inhibitors. Stannous salts are known to be corrosion inhibitors for steel, copper, and aluminum surfaces. The inventors have discovered that stannous salts are uniquely suited for pre-passivation by forming a tenacious protective layer on metal surfaces even at economical treatment levels. Moreover, unlike phosphate and zinc-based passivation treatments, these stannous salt formulations can be applied at effective levels without risk of fouling heat transfer surfaces. This property enables the passivation to occur in heat-transfer water systems while the system is being placed into service and without delaying startup. Moreover, the stannous salt passivation formulations pose much less risk to the environment than the chromate, zinc, and phosphate chemistries previously used for pre-passivation.

The present disclosure provides methods for establishing a tenacious film formed by stannous salts at comparatively low levels that are more effective than prior treatment methods and compositions which use high concentrations of phosphate, zinc, and molybdate moieties. The stable passive film results in an unexpectedly significant reduction in initial corrosion rates, which is beneficial for the environment as well as for improving the cost-effectiveness of treatment. Unlike conventional films formed using prior art methods, the disclosed film formed using stannous salt formulations has been found to resist corrosion even in the absence of any dose of corrosion inhibitors for a significant period of time. Moreover, stannous-based corrosion inhibitors are tolerant to being overdosed unlike prior art programs based on zinc or phosphate programs which are prone to forming deposits that can inhibit heat transfer and flow.

In a first embodiment, there is provided a method of preventing corrosion of equipment having a corrodible metal surface that contacts water in a water system. The method may include pre-treating the corrodible metal surface before the equipment is brought into service in the water system, the pre-treating including contacting a stannous corrosion inhibitor with the corrodible metal surface, wherein the stannous corrosion inhibitor is provided in sufficient amount and for sufficient time to form a stable protective film on at least a portion of the corrodible metal surface.

In another embodiment, there is provided a method of preventing corrosion of equipment having a corrodible metal surface that contacts water in a water system. The method may include pre-treating the corrodible metal surface before the equipment is brought into service in the water system, the pre-treating including contacting a stannous corrosion inhibitor with the corrodible metal surface, wherein the stannous corrosion inhibitor is provided for between 4 hours and 72 hours and at a concentration in the range of 1 to 50 ppm in the water to form a protective film on at least a portion of the corrodible metal surface, and wherein the water system is at a temperature in the range of 20° C. to 80° C.

In another embodiment, there is provided a method of preventing corrosion of equipment having a corrodible metal surface that contacts water in a water system. The method may include bringing the equipment on-line in the water system; pretreating the corrodible metal surface before the equipment is brought into service by adding a stannous corrosion inhibitor to the water so that the water contacts the corrodible metal surface for a first period during which the stannous corrosion inhibitor is present in a first concentration; and then contacting the corrodible metal surface with the water for a second period during which the stannous corrosion inhibitor is present in a second concentration that is from about 5 to 10 times lower than the first concentration.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIG. 1 is an x-ray photoelectron spectroscopic graph of a scanned mild steel coupon sample pre-treated with a stannous-based corrosion inhibitor; and

FIG. 2 is a graph showing electrochemical open circuit potential results of disclosed methods according to embodiments of the invention; and

FIG. 3A-3D are photographs illustrating results of copper plating experiments according to comparative techniques and according to embodiments of the invention.

### DETAILED DESCRIPTION

Overview

Embodiments of the disclosed methods of preventing corrosion of equipment having a corrodible metal surface that contacts water in a water system may comprise pre-treating the corrodible metal surface before the equipment is brought into service in the water system, the pre-treating including contacting a stannous corrosion inhibitor with the corrodible metal surface, wherein the stannous corrosion inhibitor is provided in sufficient amount and for sufficient time to form a protective film on at least a portion of the corrodible metal surface. This pre-treatment method can be used to pre-clean and pre-passivate various metals and alloys such as carbon steel, ferrous metals, aluminum metals, brass, copper containing alloys, and galvanized steels, and the like.

Corrosion inhibitors particularly suitable for use with the disclosed methods are multivalent (found in at least two different oxidation states), MX+ and MY+, in which the lower oxidation state metal ion, such as Tin(II), is more soluble in aqueous solutions than a higher oxidation state metal ion, such as Tin(IV). For such metals, the lower oxidation state species can be introduced into the treated system by, for example, introducing a metal salt directly or by feeding a concentrated solution into the treated system. Corrosion inhibitors are consumed within a treated system in various ways. These consumption pathways can be categorized as system demand and surface demand. Together, system demand and surface demand comprise total inhibitor demand.

System demand, in many scenarios, is attributed to the presence of oxygen, halogens, other oxidizing species and other components in the aqueous system that can react with or remove, and thereby deactivate or consume, the inhibitor. With stannous salt treatments, for example, oxidizing species can convert the preferred Tin(II) stannous ions to largely ineffective (at least in the process water stream) Tin(IV) stannate ions. System demand also includes inhibitor losses associated with bulk water loss through, for example, blow down and/or other discharges from the treated system.

Surface demand is the consumption of the inhibitor attributed to the interaction between the inhibitor and a reactive metal surface. Surface demand will decline as the inhibitor forms a protective film or layer on those metal surfaces that were vulnerable to corrosion. Once all of the wetted surfaces have been adequately protected, the surface demand will be nothing or almost nothing. Because the pre-treatment methods according to embodiments focus on treating the metal rather than treating the water, once the surface demand is reduced to values close to zero, the requirement for additional corrosion inhibitor can be substantially reduced or even terminated for some period of time without compromising the effectiveness of the corrosion inhibition.

Stannous compounds undergo oxidation at the vulnerable metal surfaces, or those surfaces in need of corrosion protection, and form an insoluble protective film. These metal surfaces can also react with the stannous compounds to form metal-tin complexes, which again form protective films on the metal surface. Without intending to be bound by theory, stannous inhibitors applied in accordance with the disclosed methods appear to form a protective film on reactive metals by at least three mechanisms. A first mechanism involves forming an insoluble stannous hydroxide layer under alkaline conditions. This stannous hydroxide appears to oxidize further to form a stannate oxide layer, which is even more insoluble, resulting in a protective film which is resistant to dissolution from the surface even in the absence of stannous salts in the process water. A second mechanism may be achieved under acidic conditions or in the presence of surface oxidants, for example, ferric or cupric ions, whereby the stannous salts can be directly oxidized to highly insoluble stannate salts. These stannate salts then precipitate onto the metal surface to form a protective layer and provide the desired corrosion inhibition function. A third mechanism may be achieved under alkaline conditions whereby existing metal oxides are reduced to more stable reduced forms that incorporate insoluble stannate salts in a hybrid film.

In each of the above mechanisms, the final result is a stannate film, Tin (IV), formed on or at the metal surface. The insolubility and stability of the resulting stannate film provides an effective barrier to corrosion for a limited time period even in the absence of additional stannous species being provided in the aqueous component of the treated system. The Tin (IV) film structure has been confirmed by X-ray photoelectron spectroscopy (XPS) analysis of metal surfaces. XPS reveals the presence of the Tin(IV) film on the metal coupon surface.

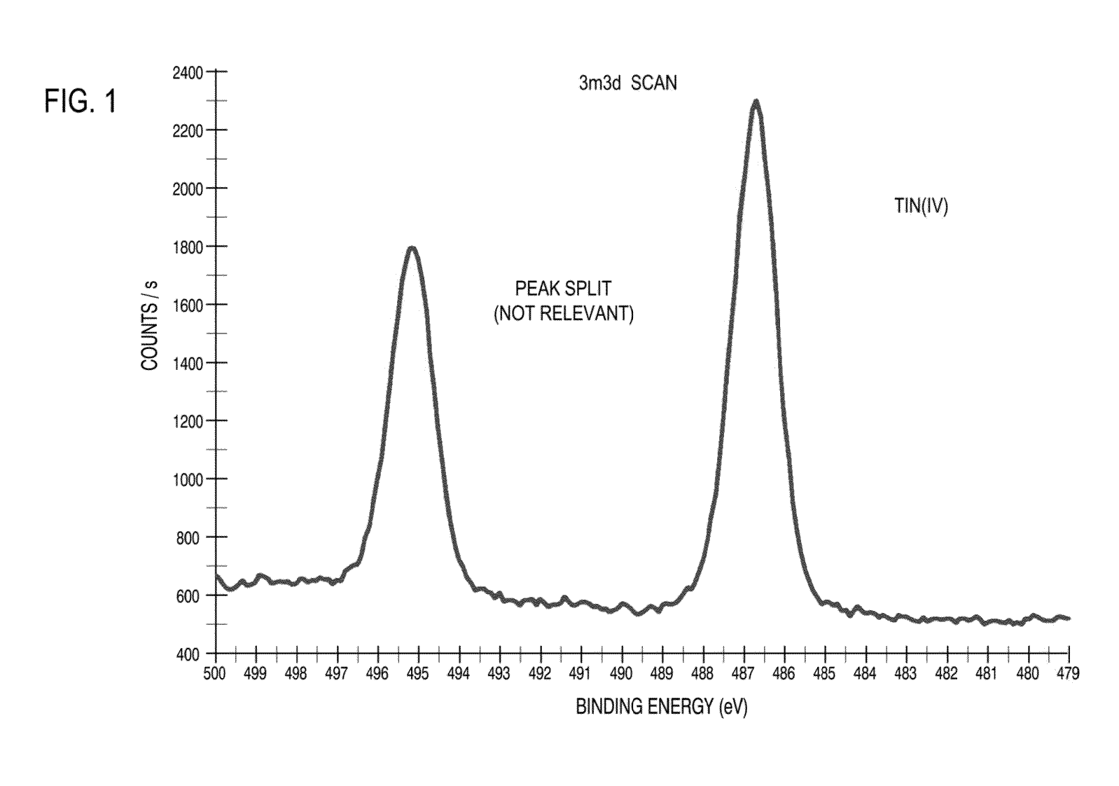

FIG. 1 illustrates an XPS examination of the chemical composition of a mild steel coupon that is pre-treated with a stannous-based passivating agent. This demonstrates that one mechanism of corrosion inhibition is by oxidation of Tin(II) to Tin(IV) and forming an insoluble Tin(IV) film on the metal surface of the coupon under these test conditions. The peak at 487 eV corresponds to Tin in the (IV) oxidation state. Similar XPS analysis was conducted on a various other metals and alloys such as, but not limited to, copper, brass, aluminum, galvanized steel, etc., coupons and the results were confirmed.

Pre-Treatment Processes

Generally, the pre-treatment of metal surfaces intended for contact with water involves pre-cleaning and pre-passivation (or pre-filming). Pre-cleaning involves removal of oxidation products, fouling, and oils to condition the surface for pre-filming or pre-passivation. After the surface has been cleaned, pre-filming provides a corrosion-resistant surface that minimizes the initial corrosion which occurs at start-up, and improves the performance of the in-service corrosion inhibitor program. Economics, discharge limitations, and time requirements dictate whether pre-treatment should be applied to the entire system or to individual heat exchangers and process equipment. Similar parameters will also dictate whether to pre-passivate the equipment on-line or off-line.

Disclosed pre-treatment methods can result in a significant reduction in the amount of corrosion inhibitor required, which is beneficial for the environment and reduces the cost of treatment. The pre-treatment methods can also provide for more economical downstream treatment of large volume systems including, for example, once-through applications and other systems in which the water consumption and losses pose a significant challenge for dosage and control using conventional anti-corrosion treatments.

Disclosed embodiments using stannous inhibitors are also beneficial if the effluent from the treated system is being used in a manner or for a purpose where a conventional inhibitor would be regarded as a contaminant or otherwise detrimental to the intended use. Such stannous-based corrosion inhibitors are more tolerant of overdosing when compared to conventional zinc or phosphate programs which rely on polymeric dispersants to suppress formation of unwanted deposits.

Moreover, historically, stannous inhibitors, such as stannous chloride, have not been known to form passive films. The inventors have discovered the unexpected advantages of using stannous-based corrosion inhibitors in forming stable passive films during pre-treatment. The inventors have further discovered the surprising effectiveness of these treatments in pre-passivating on-line systems. In conventional phosphate-based pre-passivation treatments that form protective layers, problems exist in that these treatments require near continuous treatment in order to avoid flash corrosion. Continuous treatment with conventional inhibitors may result in undesirable scaling from excess corrosion inhibitor. In order to prevent undesirable scaling, the system requires flushing or blow down to remove to remove excess inhibitor. In the case of disclosed stannous-based pre-passivation methods, there is also a reduced need to discard excess inhibitor or flush the system because the protective layer lasts longer so that there is less need for continuous treatment and the stannous inhibitors are more environmentally friendly. In embodiments, at least some of the stannous corrosion inhibitor applied during pre-treatment may remain in the water system once the equipment is brought into service.

According to embodiments, it may not be necessary to take individual components off-line for treatment. In conventional treatments, equipment, such as heat exchangers, need to be removed from on-line systems and treated off-line to avoid the negative effects of scaling and constant discharge in the on-line system. Further, according to embodiments, the time from pre-passivation to maintenance or service treatment can be much longer, on the order of several days, as compared to conventional treatments where flash corrosion is imminent in the absence of constant inhibitor treatment.

Pre-Treatment Corrosion Inhibitors/Mechanisms

Thus, disclosed embodiments are unexpectedly beneficial in at least the following ways. First, disclosed stannous-based pre-passivation methods can be used to pre-treat equipment for corrosion while the equipment is on-line. Second, disclosed stannous-based pre-passivation methods provide an unexpectedly stable passivation film that reduces the time required to regular corrosion treatment. Third, disclosed stannous-based pre-passivation methods eliminate or substantially reduce the need for constant discharge to offset scaling.

Stannous-based inhibitor compositions used in disclosed pre-passivation methods may also be applied in regular treatment, thus eliminating the need for different passivation chemistries during the regular treatment phase than in pre-passivation. This may be beneficial in on-line systems where the concentration of the stannous-based inhibitor composition may be gradually reduced from the pre-passivation concentration to the maintenance concentration. Pre-passivation concentrations may be on the order of 1 to 100 times, or more preferably, 5 to 10 times, higher than the concentration of maintenance treatment doses. In treatments with conventional inhibitors, the system is typically off-line and the entire pre-passivation treatment is blown down or purged, such that switching to the maintenance dose may require a step-wise dosing schedule.

Embodiments of the disclosed methods may include pre-treating equipment in an industrial water system such as, for example, an open cooling water system, with Tin(II) for a sufficient time and sufficient amount to form a protective passive Tin(IV) layer that resists further corrosion when the system is first placed into service, e.g., during a start-up period. Alternatively, the pre-treatment composition may be recirculated in solution through individual equipment components to form a protective film that resists corrosion during periods of storage, lay-up, or out-of-service conditions. As a result, the system may be brought into service and operated for extended periods without the further addition of corrosion inhibitor. The equipment may be pre-treated on-line, before start-up, or off-line at any time.

Depending on the particular system, the feeding can be implemented in several ways. As such, controlling the feeding can be important in arriving at the optimal pre-treatment plan for a particular system. The concentration of the corrosion inhibitor in the water stream during the pre-treating step may be from about 1 to 50 ppm, or 2 to 20 ppm, or more preferably about 5 ppm. The duration of the corrosion inhibitor in the water stream during the pre-treating step may be from about 2 hours to 1 week, or more preferably, 24 hours to 72 hours. During this time, a stable Tin(IV) film forms.

Once a stable Tin(IV) film is formed, the system may then be brought into service from about 4 hours to 2 weeks, or more preferably, 8 hours to 4 days after the pre-treating step. Once in service, the system can operate for up to a few days or several weeks without the need for further inhibitor in the system. For example, the system may operate without the need for further inhibitor for between 1 day and 2 weeks. This protective film allows for establishing and stabilizing the in-service, on-line treatment program. Thicker protective films provide for longer-lasting protection. Once pre-passivated with a protective film, the system or equipment can be operated or stored for extended periods without the further addition of corrosion inhibitor.

Once in service, the system may also be operated for an initial period during which the water contains an initial concentration of the stannous corrosion inhibitor and for a subsequent period(s) during which the water contains a subsequent concentration(s) of the stannous corrosion inhibitor that is lower than the initial or previous concentration(s). The initial period may be 2 hours to 1 week, or more preferably, 24 hours to 72 hours. The initial concentration may be zero, between 1 to 10 ppm, or more preferably, 1 to 5 ppm in the water. Subsequent periods and concentrations may be similar to the initial period/concentration, or more preferably, less than the initial period/concentration. For example, the subsequent period may be 1 hour to 12 hours, or more preferably, 2 hours to 6 hours. The subsequent concentration may be 1 to 3 ppm, or more preferably, 0.25 to 1 ppm in the water.

Disclosed embodiments may include pre-treating at room temperature or the temperature of normal operation of the water system. For example, the pre-treating step may be conducted at 10° C. to 80° C., or more preferably, 20° C. to 55° C.

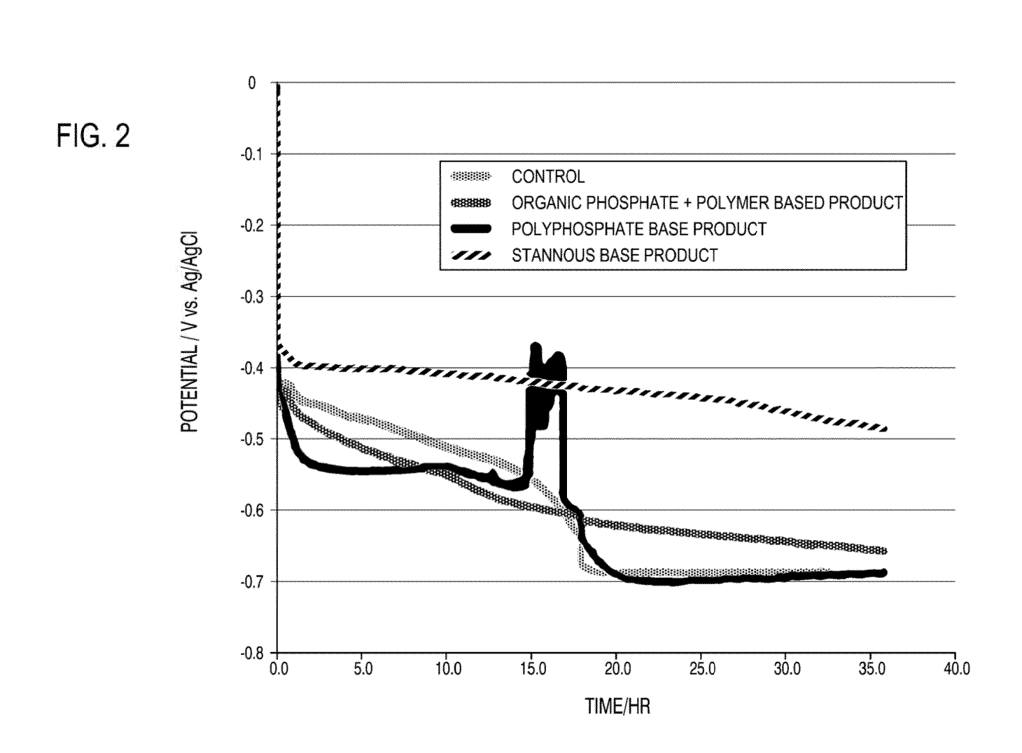

FIG. 2 illustrates the unexpected results of the disclosed pre-treatment methods. FIG. 2 shows the electrochemical open circuit potential (OCP) results over time after initially pre-treating the mild steel coupons in various treatments for 6 hours and then placing the passivated coupons into untreated water. The treatments included a conventional organic phosphate and polymer-based product, a conventional polyphosphate-based product, a control group with no treatment and a stannous-based treatment comprising a stannous chloride corrosion inhibitor and a surfactant according to disclosed embodiments. The OCP with the stannous-based products is about 200 mV (vs. Ag/AgCl) anodic to the control and other treatment, which indicates that a stable and strong passive film is formed that provides superior corrosion protection as compared to conventional pre-passivation programs.

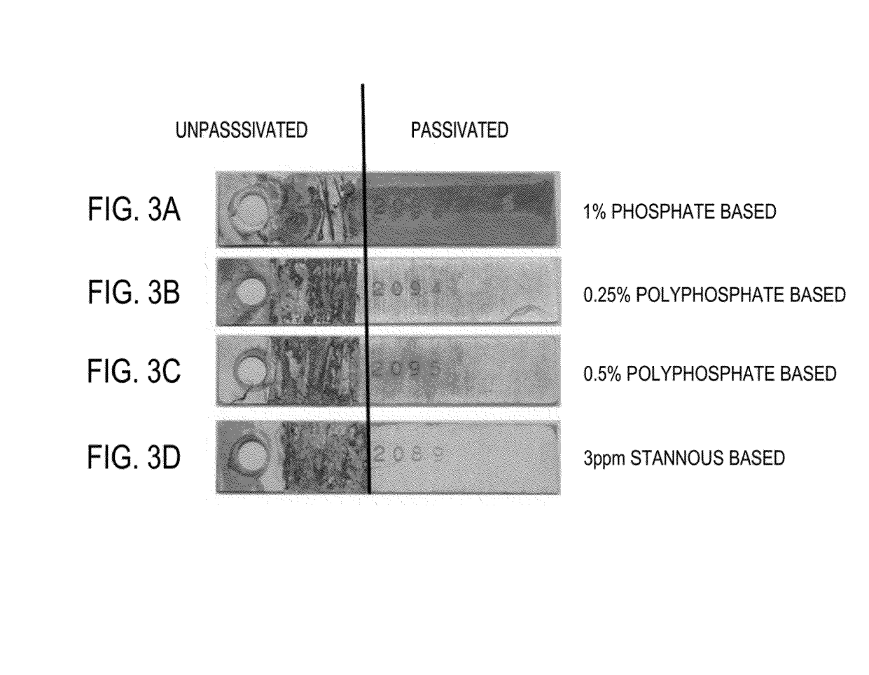

FIGS. 3A-3D show the effectiveness of the passive film on steel surfaces. These Figures illustrate the results of immersing a pre-passivated metal specimen into a copper sulfate solution for several seconds. FIG. 3A shows corrosion for coupons treated with a 1% phosphate-based pre-treatment solution. FIGS. 3B and 3C show corrosion for coupons treated with a 0.25% and 0.5% polyphosphate-based pre-treatment solution. FIG. 3D shows corrosion for coupons treated with 3 ppm stannous-based pre-treatment comprising a stannous chloride corrosion inhibitor and a surfactant. Water chemistry used for passivating the coupons consisted of 200 ppm Ca as CaCO₃, 100 ppm alkalinity as CaCO₃ and 100 ppm Mg as CaCO₃. Corroding steel surfaces act as a source of electrons causing free copper ions in solution to electroplate onto the surface according to the following formula:

Cu⁺²+2e⁻→Cu⁰ (precipitate)

The right-hand half of the steel coupons shown in FIGS. 3A-3D were pre-passivated in various treatments for six hours. Following the passivation step, the entire coupon was immersed in a 10% CuSO₄ solution for 20 seconds. FIG. 3D clearly shows that the stannous-based pre-treatment solution forms a stable passive film that resists copper plating, while the other traditional treatments are not as effective.

In preferred embodiments, the corrosion inhibitor is provided as a stannous salt selected from the group consisting of stannous sulfate, stannous bromide, stannous chloride, stannous oxide, stannous phosphate, stannous pyrophosphate, and stannous tetrafluoroborate. Other reactive metal salts such as, for example, zirconium, aluminum, and titanium salts, triazole or imidazoline or mixtures thereof may also be used in pre-treatment methods according to this disclosure. For example, embodiments of the disclosed methods may be operable with any metal salt capable of forming stable metal oxides resistant to dissolution under the conditions in the targeted system.

The method and manner by which a corrosion pre-treatment is infused into a water stream for on-line pre-treatment is not particularly limited by this disclosure. Treatment can be infused into the water system at a cooling tower, for example, or any suitable location of the water stream in the water system. Methods for infusing the corrosion treatment, including controlling the flow of the infusion, may include a multi-valve system or the like, as would be understood by one of ordinary skill in the art. Moreover control of the treatment while in the system is not particularly limited. Infusion control, including frequency, duration, concentrations, dosing amounts, dosing types and the like, may be controlled manually or automatically through, for example, an algorithm or a non-transitory computer medium executable by, for example, a CPU.

The amount of the pre-treatment dose can be applied based on the system demand and surface demand for the inhibitor. Controlling the pre-treatment dose can utilize a number of parameters associated with surface and system demands including, for example, the concentration of corrosion products in the water or the demand of a surface of the metal for reduction species. Other parameters such as on-line corrosion rates and/or oxidation-reduction potential (ORP) may also be used for controlling the frequency or concentration of a subsequent dose or doses and for monitoring system performance. In preferred embodiments, the ORP of the pre-passivation solution may be controlled to regulate the rate of Tin(II) to Tin(IV) formation and thickness of the passive film on the surface of the metal.

The pre-treatment composition may include, in addition to the corrosion inhibitor or a salt thereof, such as stannous chloride or the like, many other materials. For example, the treatment may comprise at least one of a surfactant, a polymeric dispersant, an oxidation agent, a reducing agent, a complexing agent, a degreaser and deruster, a stabilizer, and at least one of benzotriazole and 2-Butenedioic acid (Z), bicarbonates for increasing the alkalinity of the solution, a polymeric dispersant, such as 2-acrylamido-2-methylpropane sulfonic acid (AMPS), for inhibiting silt or fouling, and polymaleic acid (PMA) for inhibiting scaling. The treatment may include, for example, ChemTreat FlexPro™ CN5600, manufactured by ChemTreat, Inc., or the like.

Pre-passivation compositions according to embodiments may differ from compositions applied in regular or maintenance treatments. For example, in preferred embodiments, pre-passivation compositions may comprise a surfactant, a polymer and a dispersant to increase stability and reduce scaling. While regular treatments may require the use of a reducing agent for oxygen scavenging, pre-passivation compositions usually do not require a reducing agent since there is less concern about maintaining the active form of tin, Tin(II), during the one-shot pre-passivation phase. Conversely, ongoing treatments may rely on maintaining Tin(II).

The oxidation agent may be any suitable oxidation agent such as, for example, hydrogen peroxide, chlorine, bromine, or chlorine dioxide. Use of an oxidation agent may promote rapid film formation in small systems or at lower stannous dosages, thus increasing the overall effectiveness of the stannous-based pre-treatment program.

The reducing agent may be any suitable reducing agent such as, for example, erythorbic acid, sulfites, or N,N-diethylhydroxylamine (DEHA). Use of a reducing agent may retard the rate of film formation in larger systems or at higher stannous dosages, thus increasing the overall effectiveness of the stannous-based pre-treatment program.

The complexing agent may be any suitable complexing agent such as, for example, citric acid, glycolic acid, 1-hydroxy ethylidene-1,1-diphosphonic acid (HEDP), ethylenediaminetetraacetic acid (EDTA), or nitrilotriacetic acid (NTA). The use of a complexing agent facilitates stannous salt film formation.

The stabilizer may be any suitable stabilizer such as, for example, glycolic acid, polymaleic acid, polyacrylic acid, or any polycarboxylic acid. Use of a stabilizer stabilizes the pre-treatment solution during passivation, thus increasing the overall effectiveness of the stannous-based pre-treatment program.

The disclosed pre-treatment composition may further comprise at least one secondary corrosion inhibitor. The secondary corrosion inhibitor may include, for example, one or more of unsaturated carboxylic acid polymers such as polyacrylic acid, homo or co-polymaleic acid (synthesized from solvent and aqueous routes); acrylate/2-acrylamido-2-methylpropane sulfonic acid (APMS) copolymers, acrylate/acrylamide copolymers, acrylate homopolymers, terpolymers of carboxylate/sulfonate/maleate, ter polymers of acrylic acid/AMPS; phosphonates and phosphinates such as 2-phosphonobutane-1,2,4-tricarboxylic acid (PBTC), 1-hydroxy ethylidene-1,1-diphosphonic acid (HEDP), amino tris methylene phosphonic acid (ATMP), 2-hydroxyphosphonocarboxylic acid (HPA), diethylenetriamine penta(methylene phosphonic acid) (DETPMP), phosphinosuccinic oligomer (PSO); salts of molybdenum and tungsten including, for example, nitrates and nitrites; amines such as N,N-diethylhydroxylamine (DEHA), diethyl amino ethanol (DEAE), dimethylethanolamine (DMAE), cyclohexylamine, morpholine, monoethanolamine (MEA); azoles such as tolyltriazole (TTA), benzotriazole (BZT), butylbenzotriazole (BBT), halogenated azoles, their salts and mixtures thereof.

If desired, additional corrosion inhibition and/or water treatment chemistry known in the art can be introduced into the system in conjunction with the pre-treatment and subsequent dosing to further improve corrosion performance and control deposition of undesirable species. As will be appreciated, the pre-treatment methods according to the disclosure can be paired with other treatment or conditioning chemistries that would be compromised by the continuous presence of the corrosion inhibitor. Alternatively, “greener” treatment packages or treatment packages designed to address other parameters of the system operation can be utilized along with the pre-treatment feedings to improve the quality of the system effluent and/or reduce the need for effluent treatment prior to discharge.

Disclosed methods may further comprise measuring a parameter of the metal surface or water stream. Disclosed methods may further comprise introducing at least one subsequent dose of the pre-treatment composition and controlling the formation of the protective film based on the parameter. As will be appreciated, the frequency of the pre-treatment dosing and the inhibitor concentration necessarily will be a function of the system being treated and can be set and/or adjusted empirically based on test or historical data. The success of the pre-treatment dosing may be evaluated by monitoring the system or surface demand. The system demand, in turn, can be measured indirectly by monitoring parameters such as ORP and oxygenation levels. According to embodiments, the pre-treatment method may further comprise measuring and monitoring a characteristic of the metal surface or water stream particularly after the pre-treatment or any subsequent dose to determine the duration, concentration or frequency of pre-treatment doses.

In embodiments, the duration of introducing the pre-treatment dose is controlled based on the measured parameter, and the concentration of the corrosion inhibitor in the water stream during any second or subsequent dose is controlled based on the measured parameter. The measured parameter may be indicative of a surface demand of the metal surface for the corrosion inhibitor. The measured parameter may be indicative of a corrosion rate of the metal surface. For example, the measured parameter may be at least one of online corrosion rates, water chemistry, concentration of oxidizing species in water, and oxidation reduction potential.

Disclosed embodiments may be used in a variety of water systems including, but not limited to, cooling towers, water distribution systems, boilers, water/brine carrying pipelines, storage tanks, food systems, waste treatment plants, and the like.

### EXAMPLES

The following Examples illustrate applications of the methods disclosed herein.

### Example 1

Table 1 below illustrates a comparison of the effectiveness of two conventional phosphate-based treatments (Comparative Examples A and B) against a stannous-based treatment (Example C):

| | |
|---|---|
| Comparative | Organic Phosphate + Polymer |
| Example A: | |
| Comparative | Polyphosphate-based |
| Example B: | |
| Example C: | Stannous-based treatment comprising a stannous |
| | chloride corrosion inhibitor and a surfactant |

Experiments were conducted in water containing 200 ppm Ca as CaCO₃, 100 ppm alkalinity as CaCO₃ and 100 ppm Mg as CaCO₃, similar to typical industrial water. Corrosion rates were compared between the treatments during passivation and also after passivation and placing the passivated coupons into untreated water. Example C exhibits lower corrosion rates than either Comparative Example A or B and at a much lower concentration. Further, during post-passivation, Example C exhibits significantly better anti-corrosion impact than Comparative Example A or B.

TABLE 1
Comparative effectiveness of stannous-
based pre-passivation treatment programs.

| | | Concentration | Avg Corrosion Rate |
|---|---|---|---|
| Method | Treatment | (mg/L) | on Mild Steel (mpy) |
| During Passivation | Comparative | 20,000 | 9.8 |
| | Example A | | |
| | Comparative | 5,000 | 4.4 |
| | Example B | | |
| | Example C | 15 | 3.5 |
| Post-Passivation | Comparative | 0 | 38.5 |
| (in blank water) | Example A | | |
| | Comparative | 0 | 13.7 |
| | Example B | | |
| | Example C | 0 | 3.6 |

These results clearly demonstrate the superior effectiveness in terms of corrosion prevention of stannous-based programs for pre-passivation compared to prior art.

### Example 2

Table 2 below illustrates a comparison of the effectiveness of two conventional molybdate and nitrite-based programs treatments (Comparative Examples D and E) against stannous-based treatments (Examples F and G):

| | |
|---|---|
| Comparative | Molybdate-based |
| Example D: | |
| Comparative | Nitrite-based |
| Example E: | |
| Example F: | Stannous-based treatment comprising a stannous |
| | chloride corrosion inhibitor and a surfactant |
| Example G: | Stannous-based treatment comprising a stannous |
| | chloride corrosion inhibitor and a surfactant |

Experiments were conducted in water containing 200 ppm Ca as CaCO₃, 100 ppm alkalinity as CaCO₃ and 100 ppm Mg as CaCO₃. Corrosion rates were compared between the treatments during passivation and also after passivation and placing the passivated coupons into untreated water. As in Example 1, the stannous-based treatments (Examples F and G) exhibit significantly better anti-corrosion impact during post-passivation compared to either conventional treatment, Comparative Example D or E. Examples F and G also exhibit at least as effective anti-corrosion ability during passivation as compared to Comparative Examples D and E, but require significantly less concentration.

TABLE 2
Comparing various pre-passivation programs.

| | | Concentration | Avg Corrosion Rate |
|---|---|---|---|
| Method | Treatment | (mg/L) | on Mild Steel (mpy) |
| During Passivation | Comparative | 60.0 | 1.58 |
| | Example D | | |
| | Comparative | 1,200.0 | 1.58 |
| | Example E | | |
| | Example F | 7.5 | 1.19 |
| | Example G | 15.0 | 1.58 |
| Post-Passivation | Comparative | 0 | 7.15 |
| (in blank water) | Example D | | |
| | Comparative | 0 | 14.42 |
| | Example E | | |
| | Example F | 0 | 3.23 |
| | Example G | 0 | 2.87 |

These results clearly demonstrate the effectiveness of pre-treatment with stannous based programs post-passivation.

### Example 3

Table 3 below illustrates a comparison of the effectiveness of various concentrations of stannous-based treatments (Examples H, I and J):

| | |
|---|---|
| Example H: | Stannous-based treatment comprising a stannous |
| | chloride corrosion inhibitor and a surfactant |
| Example I: | Stannous-based treatment comprising a stannous |
| | chloride corrosion inhibitor and a surfactant |
| Example J: | Stannous-based treatment comprising a stannous |
| | chloride corrosion inhibitor and a surfactant |

Experiments were conducted in water containing 200 ppm Ca as CaCO₃, 100 ppm alkalinity as CaCO₃ and 100 ppm Mg as CaCO₃. Corrosion rates were compared between the treatments during passivation and also after passivation and placing the passivated coupons into untreated water. As seen in Table 3, the anti-corrosive effect of stannous-based treatment generally is generally proportional to the concentration.

TABLE 3
Comparing various dose concentrations of
stannous based pre-passivation programs.

| | | Concentration | Avg Corrosion Rate |
|---|---|---|---|
| Method | Treatment | (mg/L) | on Mild Steel (mpy) |
| During Passivation | Example H | 3.5 | 5.2 |
| | Example I | 7.0 | 2 |
| | Example J | 15.0 | 0.8 |
| Post-Passivation | Example H | 0 | 4.8 |
| (in blank water) | Example I | 0 | 3.8 |
| | Example J | 0 | 1.9 |

It will be appreciated that the above-disclosed features and functions, or alternatives thereof, may be desirably combined into different systems or methods. Also, various alternatives, modifications, variations or improvements may be subsequently made by those skilled in the art, and are also intended to be encompassed by the following claims. As such, various changes may be made without departing from the spirit and scope of this disclosure as defined in the claims.

What is claimed is:

1. A method of preventing corrosion of equipment having a corrodible metal surface that contacts water in a water system, the method comprising:
pre-treating the corrodible metal surface before the equipment is brought into service in the water system, the pre-treating including contacting a stannous corrosion inhibitor with the corrodible metal surface,
wherein the stannous corrosion inhibitor is provided in sufficient amount and for sufficient time to form a stable protective film on at least a portion of the corrodible metal surface.

2. The method of preventing corrosion according to claim 1, further comprising:
bringing the equipment into service in the water system;
then contacting the corrodible metal surface with the water for a first period during which the water contains a first concentration of the stannous corrosion inhibitor; and
then contacting the corrodible metal surface with the water for a second period during which the water contains a second concentration of the stannous corrosion inhibitor that is lower than the first concentration.

3. The method of preventing corrosion according to claim 2, wherein the equipment is brought into service 4 hours to 2 weeks after the pre-treating step.

4. The method of preventing corrosion according to claim 2, wherein the equipment is brought into service 8 hours to 4 days after the pre-treating step.

5. The method of preventing corrosion according to claim 2, wherein the first period is 2 hours to 1 week.

6. The method of preventing corrosion according to claim 2, wherein the first period is 24 hours to 72 hours.

7. The method of preventing corrosion according to claim 2, wherein the step of contacting the corrodible metal surface with the water for the first period occurs about 2 hours to 3 days after the pre-treating step.

8. The method of preventing corrosion according to claim 2, wherein the first concentration is from 1 to 5 ppm in the water.

9. The method of preventing corrosion according to claim 1, wherein the pre-treating step spans a time period of from 4 hours to 24 hours.

10. The method of preventing corrosion according to claim 1, wherein the pre-treating step spans a time period of from 6 hours to 10 hours.

11. The method of preventing corrosion according to claim 1, wherein the corrosion inhibitor is provided as a stannous salt selected from the group consisting of stannous sulfate, stannous bromide, stannous chloride, stannous oxide, stannous phosphate, stannous pyrophosphate, and stannous tetrafluoroborate.

12. The method of preventing corrosion according to claim 1, wherein the concentration of the corrosion inhibitor that contacts the metal surface in the pre-treating step is from about 1 to 50 ppm.

13. The method of preventing corrosion according to claim 1, wherein the concentration of the corrosion inhibitor that contacts the metal surface in the pre-treating step is from about 2 to 20 ppm.

14. The method of preventing corrosion according to claim 1, wherein the concentration of the corrosion inhibitor that contacts the metal surface in the pre-treating step is about 5 ppm.

15. The method of preventing corrosion according to claim 1, wherein the corrodible metal surface is a metal or alloy selected from the group consisting of ferrous metals, aluminum metals, brass, copper containing alloys, galvanized steels, carbon steels and stainless steels.

16. The method of preventing corrosion according to claim 1, wherein the equipment is on-line during the pre-treating step.

17. The method of preventing corrosion according to claim 1, wherein the pre-treating further comprises concurrently contacting the metal surface with at least one oxidation agent.

18. The method of preventing corrosion according to claim 15, wherein the oxidation agent is hydrogen peroxide.

19. The method of preventing corrosion according to claim 1, wherein the pre-treating further comprises concurrently contacting the metal surface with at least one reducing agent.

20. The method of preventing corrosion according to claim 17, wherein the reducing agent is erythorbic acid.

21. The method of preventing corrosion according to claim 1, wherein the pre-treating further comprises concurrently contacting the metal surface with at least one stabilizer.

22. The method of preventing corrosion according to claim 19, wherein the stabilizer is at least one of glycolic acid and polymaleic acid.

23. The method of preventing corrosion according to claim 1, wherein the pre-treating step further comprises concurrently contacting the metal surface with at least one complexing agent.

24. The method of preventing corrosion according to claim 21, wherein the complexing agent is citric acid.

25. The method of preventing corrosion according to claim 1, wherein the pre-treating further comprises concurrently contacting the metal surface with at least one of a degreaser and a deruster.

26. The method of preventing corrosion according to claim 1, wherein the pre-treating further comprises concurrently contacting the metal surface with at least one of other metal salts such as zirconium, aluminum, and titanium salts, triazole or imidazoline or mixtures thereof.

27. The method of preventing corrosion according to claim 1, wherein the pre-treating further comprises concurrently contacting the metal surface with at least one secondary corrosion inhibitor.

28. The method of preventing corrosion according to claim 1, wherein the protective film is a film of Tin(IV) on the metal surface.

29. The method of preventing corrosion according to claim 1, wherein the protective film is insoluble in water.

30. The method of preventing corrosion according to claim 1, wherein the water system is an open water system.

31. The method of preventing corrosion according to claim 1, wherein the pre-treating step comprises forming stannous hydroxide on the metal surface and oxidizing the stannous hydroxide.

32. The method of preventing corrosion according to claim 9, wherein the pre-treating step comprises oxidizing the stannous salt on the metal surface to form a stannic salt.

33. The method of preventing corrosion according to claim 1, wherein the equipment is a heat exchanger.

34. The method of preventing corrosion according to claim 1, further comprising:
recirculating the pre-treatment composition through individual equipment components to form a protective film that resists corrosion after the equipment is brought out of service in the water system.

35. The method of preventing corrosion according to claim 1, wherein the water system is at a temperature in the range of 20° C. to 80° C.

36. The method of preventing corrosion according to claim 1, wherein the reduction in concentration from the first concentration to the second concentration is gradual.

37. The method of preventing corrosion according to claim 1, wherein at least some of the stannous corrosion inhibitor from the pre-treating step remains in the water system once the equipment is brought into service.

38. The method of preventing corrosion according to claim 1, wherein the stable protective film is an insoluble oxide film.

39. The method of preventing corrosion according to claim 1, wherein the equipment is brought into service in the water system new or after a shutdown.

40. A method of preventing corrosion of equipment having a corrodible metal surface that contacts water in a water system, the method comprising:
pre-treating the corrodible metal surface before the equipment is brought into service in the water system, the pre-treating including contacting a stannous corrosion inhibitor with the corrodible metal surface,
wherein the stannous corrosion inhibitor is provided for between 4 hours and 72 hours and at a concentration in the range of 1 to 50 ppm in the water to form a protective film on at least a portion of the corrodible metal surface, and
wherein the water system is at a temperature in the range of 20° C. to 80° C.

41. A method of preventing corrosion of equipment having a corrodible metal surface that contacts water in a water system, the method comprising:
bringing the equipment on-line in the water system;
pretreating the corrodible metal surface before the equipment is brought into service by adding a stannous corrosion inhibitor to the water so that the water contacts the corrodible metal surface for a first period during which the stannous corrosion inhibitor is present in a first concentration; and
then contacting the corrodible metal surface with the water for a second period during which the stannous corrosion inhibitor is present in a second concentration that is from about 5 to 10 times lower than the first concentration.

42. The method of preventing corrosion according to claim 41, wherein the reduction in concentration from the first concentration to the second concentration is gradual.
